(19) United States
(12) Patent Application Publication
(10) Pub. No.: US 2015/0042967 A1
(43) Pub. Date: Feb. 12, 2015

(54) PROJECTION HEAD FOR A LASER PROJECTOR

(71) Applicant: LDT Laser Display Technology GmbH, Jena (DE)

(72) Inventors: Wolfram BIEHLIG, Jena (DE); Andreas ZINTL, Arnstadt (DE)

(21) Appl. No.: 14/465,661

(22) Filed: Aug. 21, 2014

Related U.S. Application Data
(63) Continuation of application No. PCT/EP2013/053242, filed on Feb. 19, 2013.

(30) Foreign Application Priority Data
Feb. 21, 2012 (DE) 10 2012 202 637.1

(51) Int. Cl. G03B 21/28; G03B 21/20

(52) U.S. Cl. CPC G03B 21/28; G03B 21/208
USPC 353/97; 353/98

(57) ABSTRACT

A projection head for a laser projector is provided that includes a fiber outcoupling with a relatively large distance between the fibers. The fiber outcoupling represents a possibility for being able to adjust the position of the crossing point between the light beams. Thus it is possible to place the crossing point on the polygonal facets of a polygonal mirror. As a result, only minor light losses occur and edge discolorations are reduced when projecting onto a projection surface. The lateral distance between the fibers is relatively large, amounting to several millimeters. Due to the large distance, it is possible to integrate additional adjustment device and use conventional fiber plugs for the individual fibers.

This nonprovisional application is a continuation of International Application No. PCT/EP2013/053242, which was filed on Feb. 19, 2013, and which claims priority to German Patent Application No. 10 2012 202 637.1, which was filed in Germany on Feb. 21, 2012, and which are both herein incorporated by reference.

### BACKGROUND OF THE INVENTION

1. Field of the Invention

The invention relates to a projection head for a laser projection, in particular to the fiber outcoupling at a relatively large distance between the fibers, therefore a new concept for improving the optical properties of the projector head in scanning laser projection. For this purpose, a fiber outcoupling is presented which affords advantages over previous solutions with a fiber duo. It represents a possibility of being able to set the position of the intersection point between the light beams. Thus, it is possible to place the intersection point on the polygon facets of a polygon (mirror). As a result, there are still only minor losses of light, and edge discolorations when projecting onto a projection surface are reduced. The lateral distance between the fibers is relatively great and constitutes a few millimeters. Due to the large distance, it is possible to integrate additional adjustment devices and to use conventional fiber plugs for the individual fibers.

2. Description of the Background Art

In a laser projection the light is transported from a laser source to a projection channel via an optical fiber. The image quality is determined in this case decisively by the optics design in the area between the ends of the fiber duo and the two-axis scanner. The divergent light beams emerging from both light fibers are collimated by a collimating lens. Because of the distance of the fiber duo, different points of impact on the polygon result simultaneously. This beam displacement leads to a degradation of the image quality. In particular, the inhomogeneity of the brightness distribution in the image intensifies. In addition, edge discolorations can occur. The diaphragm eliminates a major part of the scattered light.

Such a known arrangement of the implementation of the fiber outcoupling for a fiber duo according to the state of the art is shown in FIG. 12 <State of the art22 . In the laser projector, the light is transported from the laser source to the projection channel via optical fibers 100, 101. The divergent light beams exiting the two optical fibers 100, 101 are collimated by a collimating lens 102. At the same time, different points of impact on the polygon facet mirror 104 result due to the lateral distance of fibers 100, 101 in the fiber duo.

DE 10 2004 001 389 A1 discloses an arrangement and a device for minimizing edge discolorations in video projectors. In this regard, an image made up of pixels is projected onto a projection surface. The arrangement comprises at least one light beam-emitting, variable-intensity light source and an adjustment device, downstream of a fiber and containing an optical delay for symmetrizing the light beam, and a subsequent deflection unit.

The method and device for projecting an image onto a projection surface from DE 10 2008 063 222 A1 are based on a fiber from DE 10 2004 001 389 A1 and propose constructing the deflection device with a scanner unit and suitable deflection mirrors. Further, the deflection unit comprises fixedly or movably arranged dichroic mirrors, etc., and optionally a diaphragm system.

DE 10 2007 019 017 A1, which corresponds to U.S. 20100188644, discloses a further method and a further device for projecting an image, made up of pixels, onto a projection surface with at least one light beam-emitting, variable-intensity light source and an outcoupling unit downstream of the fiber and a subsequent deflection unit, which directs the light beam onto the projection surface.

DE 41 40 786 A1, which corresponds to U.S. Pat. No. 5,136,675, concerns a projection system in which narrow fiber bundles are used for the optical connection between the light source and projector. The light beams emitted from the individual fibers are imaged via an optic on the projection screen. Different image contents can be blended by an optical element for beam coalescence. The structure of the optics is not explained in greater detail.

DE 601 24 565 T2, which corresponds to U.S. Pat. No. 7,102,700, presents a raster laser projection system, in which closely adjacent fiber optic bundles are used, to be able to scan a plurality of lines simultaneously on the projection screen. The fiber ends are imaged by an optic onto the projection screen. The different primary color components (red, green, blue) are carried by different optical fibers. So that all color hues can be produced, the colored light spots (red, green, blue) must be superimposed on the projection surface. Three or more optical fibers are used for this purpose. One or more points on the projection surface must be irradiated one after the other or simultaneously by different scans within an image, so that a superposition of the light spots, which emerge from the different optical fibers of the fiber bundle, occurs on the projection surface. The possible structure of the optic downstream of the fiber is not described in greater detail.

### SUMMARY OF THE INVENTION

It is therefore an object of the invention of improving the properties of a projection head with a simple structure, so that the image quality is improved as well.

In an embodiment, the invention is based on the idea of crossing collimated beams at the polygon facet mirror (intersection point), whereby the diaphragm is also brought into a better position, without the functionality being negatively affected in any way. To this end, the known collimating lens is replaced by new outcoupling systems. A first converging lens creates a focal point of the light beam of at least two fibers, which are tilted to one another and are arranged separated relatively far from one another, in the vicinity of the focal plane of a second converging lens, which collimates these (two) light beams. The light beams cross in front of the focal plane of the second converging lens (focusing lens). This intersection point is imaged by the second converging lens (collimating lens) in the plane of the polygon facet, where then a second intersection point is located. A scattered light diaphragm is located at the first intersection point.

The provided outcoupling optics (outcoupling system or outcoupling unit) in a first embodiment has only of converging lenses. In a further variant, the outcoupling optics are a combination of converging and diverging lenses. Because of the larger selected fiber distances, each fiber has its own focusing or converging lens. Each lens is in practice representative of a lens group. This is necessary for the necessary corrections (color errors, astigmatism, etc.) to be realized.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a first variant with at least three fibers and converging lenses;

FIG. 2 shows a further variant with at least three fibers and a combination of converging and diverging lenses;

FIGS. 3a-c show different arrangements of fiber groups in the viewing direction of the optical axis;

FIG. 4 shows a projected image according to FIG. 3c;

FIG. 5 shows an illustration of distances, necessary for the calculation, for the quantitative design of the outcoupling with use of the variant in FIG. 2;

FIG. 6 shows a basic structure of the variant in FIG. 2 with an illustration of the beam centers;

FIG. 7 shows the structure in FIG. 6 with the illustration of the beam diameters;

FIG. 8 shows a side view of an outcoupling group of the variant in FIG. 2 with a segmented mirror;

FIG. 9 shows an axial view of an outcoupling group with a segmented mirror and nine fibers;

FIG. 10 shows a side view of an outcoupling group of FIG. 9;

FIG. 11 shows an illustration of a fiber with adjustment means;

FIG. 12 shows a known arrangement of the implementation of the fiber outcoupling for a fiber duo according to the state of the art.

### DETAILED DESCRIPTION

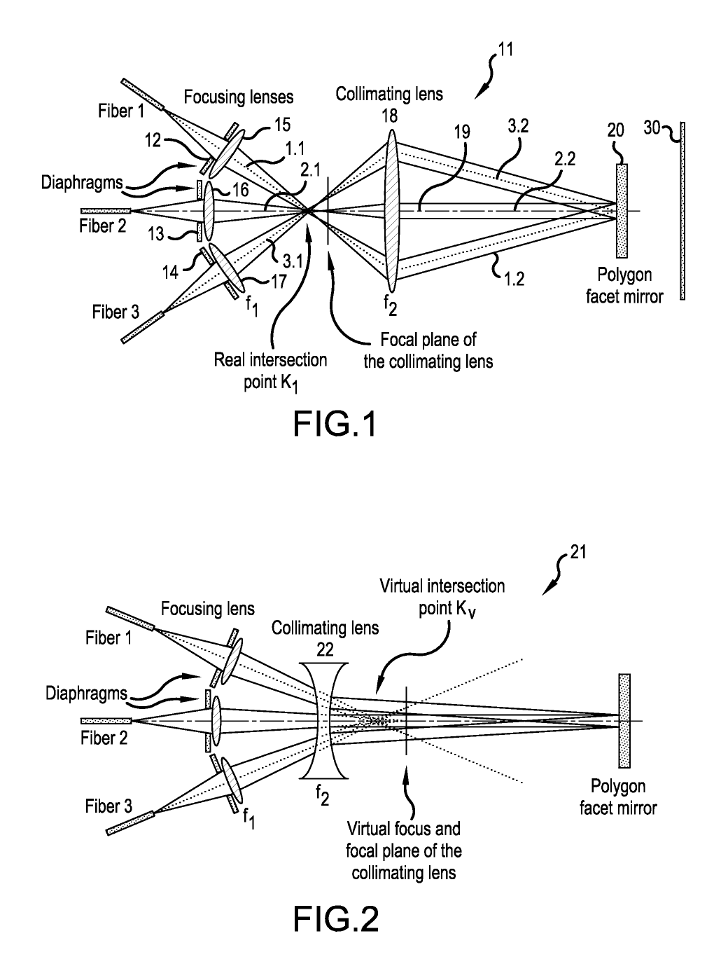

FIG. 1 shows a first outcoupling electronics 11 of a projection head (not shown in greater detail) with three spaced apart fibers 1, 2, 3, which are oriented by means of the associated diaphragms 12, 13, 14 and lenses 15, 16, 17 located behind them so that a real intersection point K₁ is located in front of the focal plane of a mutual further lens 18 (collimating lens). The shown lenses 15-17 (FIG. 1, FIG. 2) are in practice representative of a lens group, which is necessary when necessary corrections (color error, astigmatism, etc.) should be realized.

Each fiber 1, 2, 3 has its own converging lens 15-17 (focusing lens with the focal length f₁), with diaphragms 12-14, which create a focal point B in the focus of the collimating lens (focal length f₂). The collimation is realized in the second step by mutual collimating lens 18. Before collimating lens 18 is a distinct tilting of beams 1.1, 2.1, 3.1 emerging from fibers 1, 2, 3 relative to optical axis 19 (dash-dot line). As a result, a relatively large lateral distance between the fiber ends of fibers 1, 2, 3 from one another is achieved. The fiber ends thus no longer require any combined packaging. The tilting between the light beams in the region between collimating lens 18 and polygon facet 20 is much smaller than between optical fibers 1, 2, 3 (typical factor of about 8). Intersection point K₁ of lenses 15-17 is imaged by collimating lens 18 on polygon facet mirror 20. All light beams 1.2, 2.2, 3.2 therefore lie above one another on polygon facet mirror 20; i.e., there is a second real intersection point here (pupil).

According to FIG. 2, outcoupling electronics 21 has a converging lens and at least one diverging lens. Each fiber 1, 2, 3 here also has its own converging lens (focusing lens) 15-17, which creates a virtual focal point Bᵥ in the focal plane of collimating lens 22. The collimation is realized in the second step by mutual diverging lens 22.

Before diverging lens 22, there is a distinct tilting of beams 1.1, 2.1, 3.1 emerging from fibers 1, 2, 3 relative to optical axis 19 (dash-dot line). As a result, a relatively large lateral distance between the fiber ends of fibers 1 and 2 and 2 to 3 is achieved. The tilting between the light beams in the region between collimating lens 22 and polygon facet mirror 20 is much smaller than between the optical fibers (typical factor of 8-10).

Virtual intersection point Kᵥ is imaged by collimating lens 22 onto polygon facet mirror 20 with there being a real intersection point here (pupil). All light beams pass through a point on polygon facet mirror 20.

Three fibers 1-3 need not necessarily be incorporated in outcoupling optics 11, 21. The number of fibers is typically in the range between 1 and 10. There is no absolute upper limit, however.

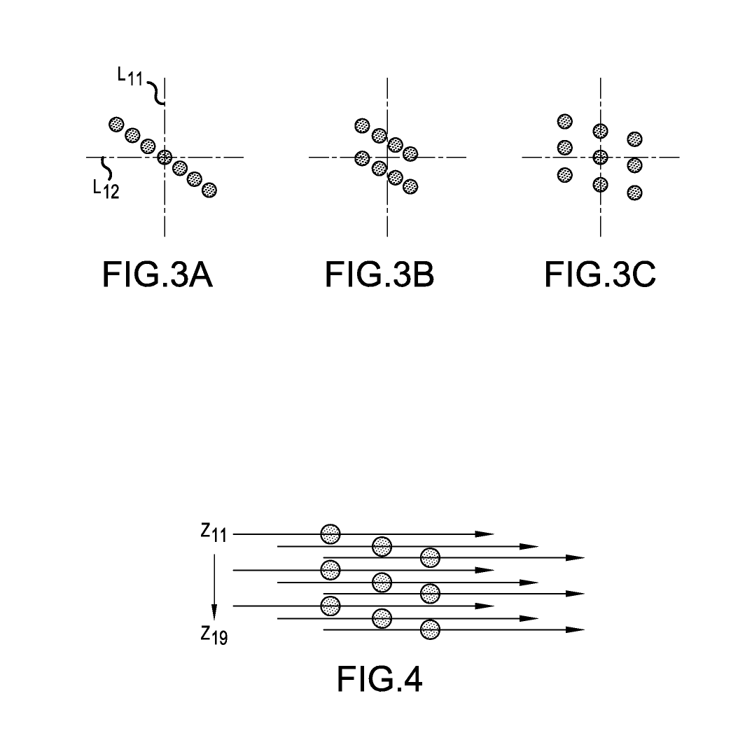

A wide variety of different realizations of the fiber group is conceivable. In this case, the fibers can also be arranged in several planes, see FIG. 3a-c. Different arrangements of fiber groups are shown in the viewing direction of optical axis 19 and, in this case, the fiber end surfaces of a plurality of fibers tilted toward one another. Optical axis 19 lies at the intersection point of the two lines L₁₁ and L₁₂. In the projected image of the fiber group according to FIG. 4, the image in FIG. 3c forms in a similar way. (The equidistantly written rows Z₁₁₋₁₉ arise only by the movement of the rotating polygon)

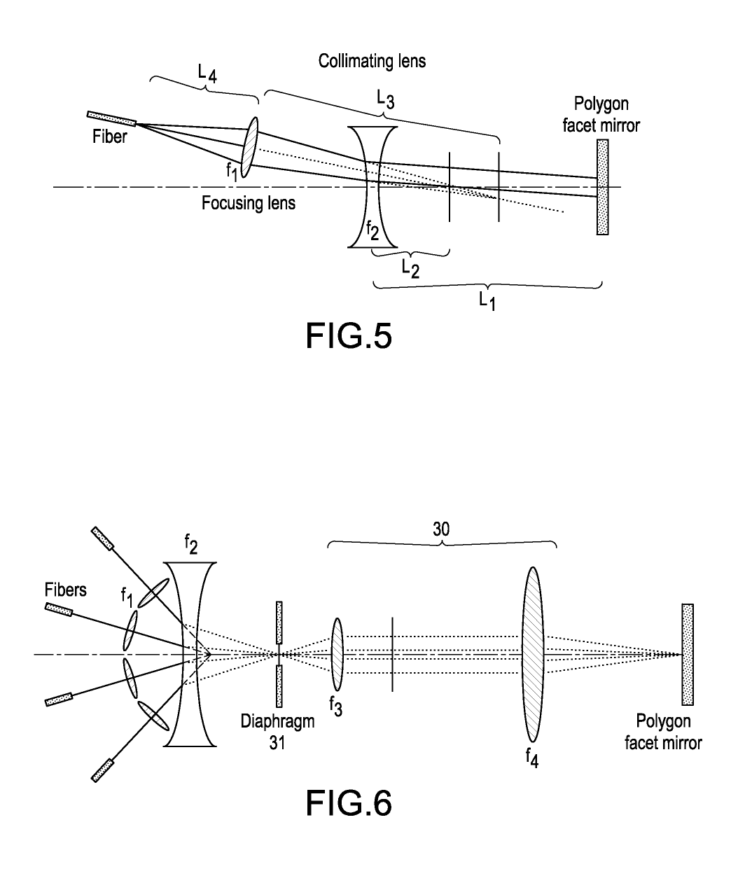

The requirements for the production tolerances are relatively high. The fibers must be arranged very accurately with respect to position and angle (tolerable distance error of about 0.5-2 μm). The necessary distances in the variants according to FIG. 1 (variant A) and FIG. 2 (variant B) can be calculated, however (FIG. 5).

Here, the symbols stand for the following:
L₁: distance of the polygon facet to the collimating lens
L₂: Variant A: distance of the first intersection point to the collimating lens (L₂<0)
Variant B: distance of the virtual intersection point to the collimating lens (L₂>0)
L₃: Variant A: distance of the focusing lenses to the first focal plane of the collimating lens
Variant B: distance of the focusing lenses to the second focal plane of the collimating lens
L₄: distance of the fiber end to the converging lens
θ₁: angle between two subbeams before the polygon facet
θ₂: angle between two subbeams after the optical fiber
f: focal length of the system to be replaced (FIG. 1)
f₁: focal lengths of the focusing lenses
f₂: focal length of the collimating lens (variant A: f₂>0, variant B: f₂<0)
D₁: beam diameter at the focusing lens
D₂: beam diameter at the collimating lens
D_{Edge}: edge strength of the focusing lens
S: lateral distance of the light beams at the focusing lenses.

The following calculations apply to the paraxial case. The Newtonian imaging equations apply:

$$\frac{1}{{f}_{1}} = \frac{1}{{L}_{3}} + \frac{1}{{L}_{4}} , \frac{1}{{f}_{2}} = \frac{1}{{L}_{1}} - \frac{1}{{L}_{2}}$$

and the following relation applies to the angles:

L₁θ₁=L₂θ₂

It is desirable that outcouplings 10, 20 of the invention during use of the same optical fibers on projection screen 30 and on the facets of polygon mirror 20 have the same beam diameter as according to the prior art.

This invariance produces the following condition:

$$\frac{{L}_{3}}{{L}_{4}} = - \frac{{f}_{2}}{f}$$

The quantities f₁, f₂, L₁, θ₁ are predefined for further calculations; all others are calculated therefrom. After basic conversions, the following is obtained from the above equations:

$${L}_{2} = {L}_{1} \frac{{f}_{2}}{{f}_{2} - {L}_{1}} , {L}_{3} = {f}_{1} ( 1 + \frac{\vert {f}_{2} \vert}{f} ) , {L}_{4} = {f}_{1} ( 1 + \frac{f}{\vert {f}_{2} \vert} )$$

$${θ}_{2} = {θ}_{1} \frac{{f}_{1} - {L}_{1}}{{f}_{2}}$$

The independent quantities are now limited further, which occurs with consideration the variable S. This variable is a critical parameter. For a reasonable constructive solution, S should therefore be preferably greater than the beam diameter+the lens edge of the focusing lenses.

The following then applies for small angles:

Variant A:s=(L₃+f₂−L₂)|θ₂|>D₁+D_{Edge}

Variant B:s=L₁θ₁+(L₃+f₂)|θ₂|>D₁+D_{Edge}

A further requirement is a positive distance between the focusing and collimating lenses:

$${L}_{3} + {f}_{2} = {f}_{1} ( 1 - \frac{{f}_{2}}{f} ) + {f}_{2} > 0$$

The focal length of the collimating lens in addition should match the beam diameters of both light beams and the distances thereof. The effective diameter of a lens is about half the value of its focal length; therefore the following applies:

$${L}_{1} {θ}_{1} + {D}_{2} \leq \vert \frac{{f}_{2}}{f} \vert$$

A similar condition applies to the focusing lenses:

$${D}_{1} \leq \frac{{f}_{1}}{2}$$

The total length of the arrangement

$${L}_{Tot} = {L}_{1} + {f}_{2} + {L}_{3} + {L}_{4} = {L}_{1} + {f}_{2} + {f}_{1} ( 2 + \frac{\vert {f}_{2} \vert}{f} + \frac{f}{\vert {f}_{2} \vert} )$$

should not be too great. Useful values for f₁, f₂, L₁ can now be determined from these conditions.

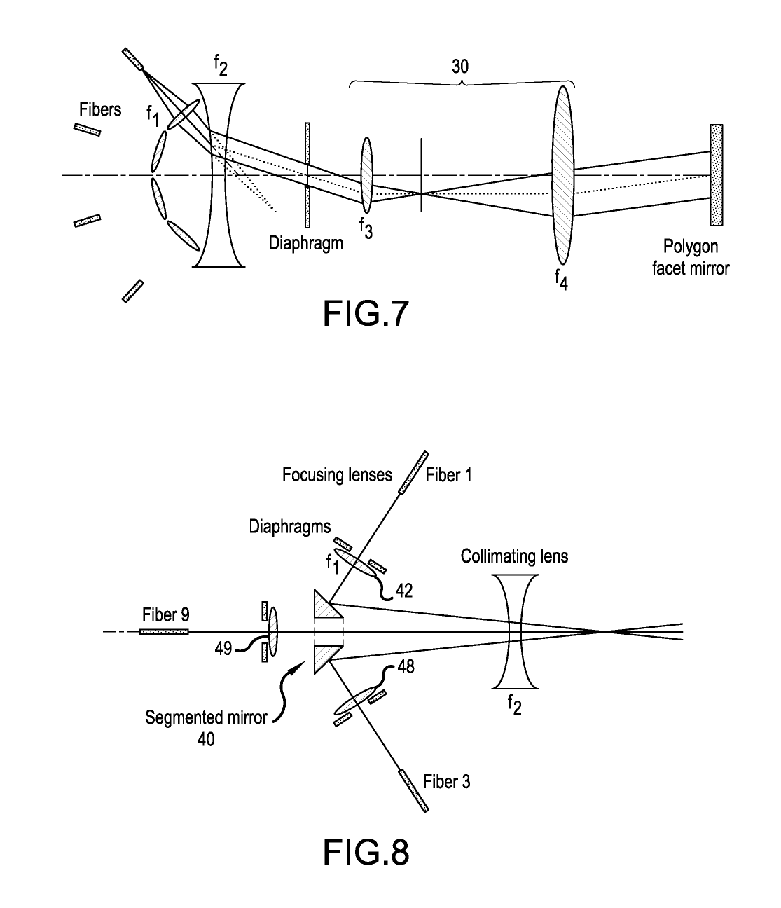

A reduction in size can be achieved further by a combination of the two variants (A and B) with a telescope 30. To this end, telescope 30 is inserted in the optical path between the fiber outcoupling and polygon facet mirror 20. The optical diagram is shown in FIG. 6 and FIG. 7 for variant B. The arrangement is the same for variant A.

A diaphragm 31 can be positioned in a meaningful manner on the output-side intersection point of the fiber outcoupling. The distance of diverging lens 21 to diaphragm 31 is L₁. Polygon facet mirror 20 is located at the focal point of the second telescope lens (exit pupil of telescope 30). The tilt angle of the light beams after the fiber outcoupling is reduced by a factor of approximately 8 by telescope 30. At the same time, the light beam is widened by the same factor. As a result, the overall length can be greatly shortened.

A further structural alternative in regard to the space problem in the region of focusing lenses 41-49 is provided by using a segmented mirror 40. The number of fibers 1, 3, 9 shown in FIG. 8 and the arrangement thereof are only exemplary here. A good spatial separation of the three shown focusing optics 42, 48, 49 is possible by segmented mirror 40.

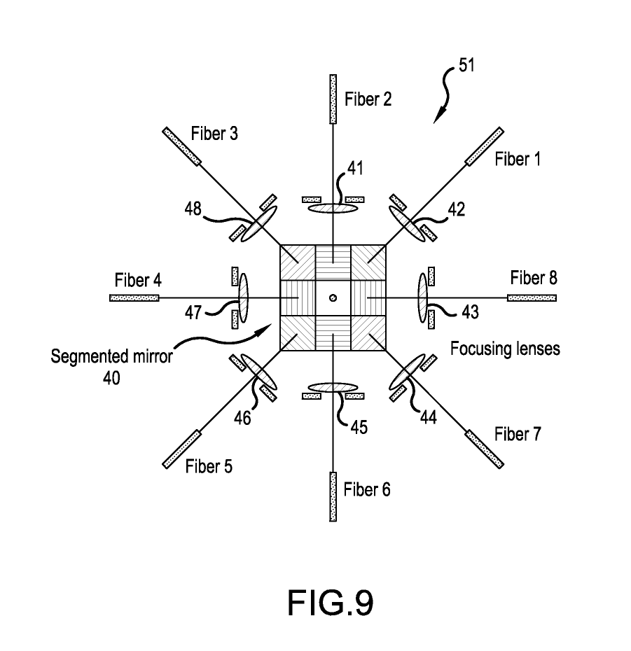

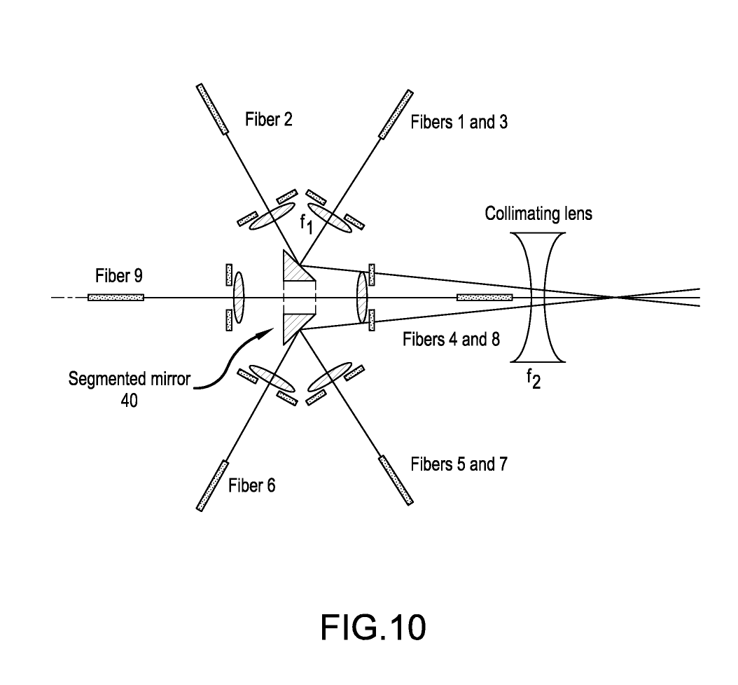

An axial view of an outcoupling group with segmented mirror 40 with the incorporated 9 fibers is shown according to FIG. 9. In this case, the ninth fiber is precisely in the axial direction. The different hatching in segmented mirror 40 shows the tilting of the individual mirror segments, several millimeters in size. A side view of outcoupling group 51 of FIG. 9 is shown in FIG. 10.

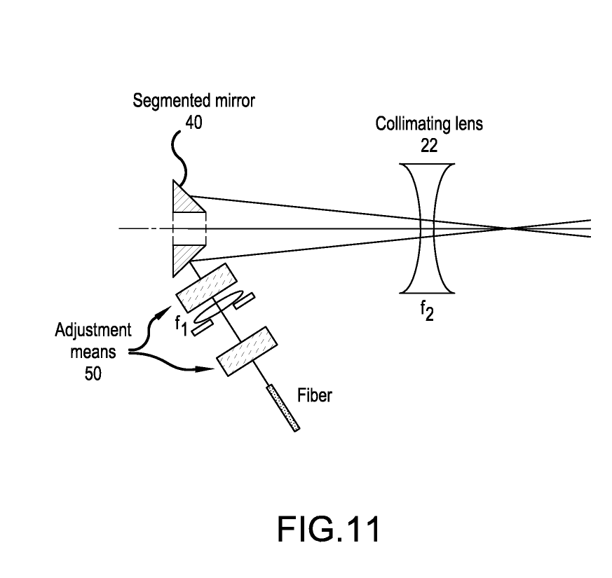

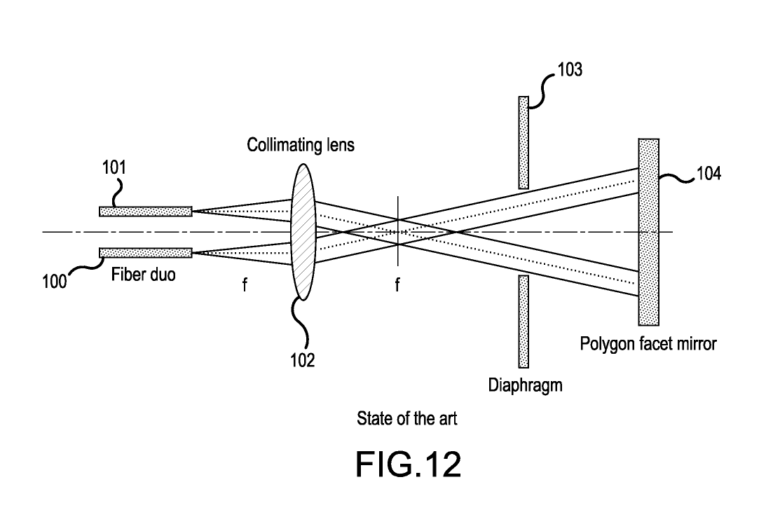

FIG. 11 shows that sufficient room for necessary adjustment device 50 can be created by this structural proposal. Possible adjustment device 50 are, for example, rotatable plane-parallel plates or optical wedges. The fine adjustment of the beam position and/or beam tilting can be made thereby.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A projection head for a laser projector, comprising:
a light source emitting a light bundle;
a polygon facet mirror; and
an outcoupling unit arranged downstream of fibers, the fibers being incorporated with a relatively large distance to one another and collimated beams are crossed at the polygon facet mirror by the outcoupling unit.

2. The projection head according to claim 1, wherein the outcoupling unit comprises converging lenses, assigned to each fiber, and a central lens, wherein the central lens is a converging lens or a diverging lens.

3. The projection head according to claim 2, wherein the spaced apart fibers are oriented so that a real intersection point is in front of a focal plane of the central lens.

4. The projection head according to claim 2, wherein the fibers are oriented so that a virtual focal point is created in a vicinity of the focal plane of the central lens, and wherein the collimation occurs by the central lens.

5. The projection head according to claim 1, wherein a telescope is inserted in an optical path between the fiber outcoupling and the polygon facet mirror.

6. The projection head according to claim 1, wherein a segmented mirror is incorporated in a region of the converging lens.

7. The projection head according to claim 6, wherein individual mirror segments are tilted differently in the segmented mirror.

8. The projection head according to claim 2, wherein the converging lenses are formed by a lens group.

9. The projection head according to claim 6, wherein, for fine adjustment of the beam position and/or beam tilting, an adjustment device is arranged in an area of the diaphragms and converging lenses.

10. The projection head according to claim 9, wherein the adjustment device includes rotatable plane-parallel plates or optical wedges.
